(19) United States
(12) Patent Application Publication
(10) Pub. No.: US 2009/0280885 A1
(43) Pub. Date: Nov. 12, 2009

(54) GAMING MACHINE ACCEPTING SIDE BET AND GAMING METHOD

(75) Inventors: Katsuhiro Kido, Tokyo (JP); Kenta Kitamura, Tokyo (JP); Hiroki Munakata, Tokyo (JP)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Aruze Corp., Tokyo (JP)

(21) Appl. No.: 12/189,361

(22) Filed: Aug. 11, 2008

Related U.S. Application Data
(60) Provisional application No. 61/052,546, filed on May 12, 2008.

(51) Int. Cl. A63F 9/24; A63F 13/00

(52) U.S. Cl. 463/13

(57) ABSTRACT

A gaming machine of the present invention executes a normal game by displaying to a display a player's card and a dealer's card, and displays as a side game a symbol display region in which a plurality of symbols are arranged in a matrix; and the gaming machine provides a special payout, when symbols corresponding to the player's card and the dealer's card are arranged in a specific arrangement within the symbol display region.

### CROSS-REFERENCE TO RELATED APPLICATIONS

This application claims benefit of priority based on U.S. Provisional Patent Application No. 61/052,546 filed on May 12, 2008. The contents of this application are incorporated herein by reference in their entirety.

### BACKGROUND OF THE INVENTION

1. Field of the Invention

The present invention relates to a gaming machine accepting a side BET and a gaming method.

2. Discussion of the Background

Conventionally, there have been gaming machines capable of accepting a side BET different from a normal BET. For example, in Blackjack, when an upcard is an “A” card out of dealer's two cards, a player can place a side BET in addition to a normal BET. In a case of placing a side BET, the player adds a wager that is half of an initial wager. When the dealer's hand is “Natural 21”, the value twice the value of the side BET is paid out. Further, for example, in Caribbean stud porker, a side BET is cumulatively accumulated as a progressive jackpot. When a player places a side BET in addition to an ante (a normal BET), he or she can acquire a part of or the entire progressive jackpot, according to the established hand. Games capable of accepting aside BET of this kind are disclosed in, for example, U.S. Pat. No. 6,789,801, U.S. Pat. No. 5,711,525 and U.S. Pat. No. 6,874,786.

Further, as disclosed in US 2006/0287043-A1 and US 2006/0009283-A1, there have existed gaming systems in which a plurality of gaming machines (player terminals) are linked and a plurality of players can play a common game.

Furthermore, as disclosed in U.S. Pat. No. 6,159,095, U.S. Pat. No. 5,882,260, US 2002/0058545-A1, and US 2002/0082074-A1, there have existed gaming machines capable of conducting a card game and a bingo game, on the displays thereof.

However, those conventional gaming machines accepting a side BET are not capable of satisfying both addition of a high game property to a game (hereinafter, also referred to as a “side game”) becoming executable by placement of a side BET, and increase of the probability of a large value of payout, such as a progressive jackpot, being paid out in the side game. For example, there has been a problem in that it is not possible to make the player aggressively place a side BET, when a value being paid out is small (e.g. twice to three times as large as the value of a side BET) even with a side BET placed or the side game itself lacks entertainment; thus, there has been a desire to develop a new type of side game.

The present invention was made in view of the above problem, and has an object of providing a gaming machine capable of making a player aggressively place a side BET and a gaming method.

The contents of U.S. Pat. No. 6,789,801, U.S. Pat. No. 5,711,525, U.S. Pat. No. 6,874,786, US 2006/0287043-A1, US 2006/0009283-A1, U.S. Pat. No. 6,159,095, U.S. Pat. No. 5,882,260, US 2002/0058545-A1, and US 2002/0082074-A1 are incorporated herein by reference in their entirety.

### SUMMARY OF THE INVENTION

A first aspect of the present invention provides a gaming machine having the following configuration.

Namely, the above-mentioned gaming machine comprises: a display capable of displaying an image; an input device; and a controller. The controller is programmed to conduct the processing of (a) accepting a normal BET from the input device, (b) accepting a side BET different from the normal BET, from the input device, (c) displaying to the display a player's card and a dealer's card, (d) executing a normal game in which winning or losing is determined based on the player's card and the dealer's card, (e) offering a normal payout based on the normal BET, when it has been determined that a player has won in the normal game, (f) displaying to the display a symbol display region in which a plurality of symbols are arranged in a matrix, when the side BET has been placed, and (g) offering a special payout, when symbols corresponding to the player's card and the dealer's card are arranged in a specific arrangement within the symbol display region.

According to the above-mentioned gaming machine, a player's card and a dealer's card are displayed to a display (e.g. a liquid crystal display) to execute a normal game, and a symbol display region in which a plurality of symbols are arranged in a matrix is displayed as a side game, when a side BET has been placed. A special award is provided when symbols corresponding to the player's card and the dealer's card are displayed in a specific arrangement (e.g. an arrangement forming a bingo combination) to the symbol display region.

Since a side game (a game in which it is determined whether or not symbols corresponding to the player's card and the dealer's card are arranged in a specific arrangement within the symbol display region) is conducted using the player's card and the dealer's card which have been dealt in the normal game, the side game is less apt to affect the game property of the normal game, and a player interested in the normal game is less apt to be hesitant to place a side BET. Moreover, since a simple but a new game property of determining arrangement of symbols within the symbol display region is added, it is possible to further increase a fascinating factor of the game itself.

Also, in the side game, since the player only has to compare the dealt cards and the arrangement of symbols within the symbol display region, he or she can quickly see the result of the side game.

When symbols corresponding to the player's card and the dealer's card are arranged in a specific arrangement within the symbol display region in the side game, the player has a possibility of gaining a large value of payout by a special payout.

It is therefore possible to make the player have a strong desire of placing a side BET.

Further, it is desirable that the gaming machine has the following configuration.

Namely, the gaming machine further comprises a memory that stores a plurality of types of arrangement pattern data each showing an arrangement pattern of symbols in the symbol display region, wherein the processing (f) is the processing of displaying to the display the symbol display region in which the plurality of symbols are arranged in a matrix, based on an arrangement pattern data selected from the plurality of types of arrangement pattern data stored in the memory, when the side BET has been placed.

According to the above gaming machine, an arrangement pattern of symbols within the symbol display region displayed in a side game is selected from a plurality of types of arrangement patterns.

Accordingly, since a symbol display region with a different arrangement pattern is displayed every time a side BET is placed, it is possible to add variations to results of side games and further increase the game property.

Further, it is desirable that the above gaming machine provides the following configuration.

Namely, the processing (f) is the processing of displaying to the display the symbol display region in which the same number of symbols are arranged in rows and columns, when the side BET has been placed, and the processing (g) is the processing of offering a special payout, when all symbols, which have been arranged in a single row, column and/or diagonal of the symbol display region, are symbols corresponding to the player's card and/or the dealer's card.

According to the above gaming machine, a special award is offered when symbols corresponding to the player's card and the dealer's card are arranged in an arrangement forming a bingo combination within the symbol display region in a side game.

It is possible to attract the attention of the players in a wide range of age groups by bringing a widely popular element of Bingo Game into the side game.

A second aspect of the present invention provides a gaming machine having the following configuration.

Namely, a gaming machine comprises: a display capable of displaying an image; an input device; and a controller. The controller is programmed to conduct the processing of (a) accepting a normal BET from the input device, (b) accepting a side BET different from the normal BET, from the input device, (c) cumulatively accumulating a predetermined ratio of game media that have been placed as a side BET in the processing (b), (d) displaying to the display a player's card and a dealer's card, (e) executing a normal game in which winning or losing is determined based on the player's card and the dealer's card, (f) offering a normal payout based on the normal BET, when it has been determined that a player has won in the normal game, (g) displaying to the display a symbol display region in which a plurality of symbols are arranged in a matrix, when the side BET has been placed, and (h) offering a special payout from the game media cumulatively accumulated in the processing (c), when symbols corresponding to the player's card and the dealer's card are arranged in a specific arrangement within the symbol display region.

According to the above-mentioned gaming machine, a player's card and a dealer's card are displayed to a display (e.g. a liquid crystal display) to execute a normal game, and a symbol display region in which a plurality of symbols are arranged in a matrix is displayed as a side game, when a side BET has been placed. A special award is provided when symbols corresponding to the player's card and the dealer's card are displayed in a specific arrangement (e.g. an arrangement forming a bingo combination) to the symbol display region.

Also, part of the side-BET game media is cumulatively accumulated, for example, as a progressive jackpot, and a special payout in the side game is provided from the accumulated game media.

Since a side game (a game in which it is determined whether or not symbols corresponding to the player's card and the dealer's card are arranged in a specific arrangement within the symbol display region) is conducted using the player's card and the dealer's card which have been dealt in the normal game, the side game is less apt to affect the game property of the normal game, and a player interested in the normal game is less apt to be hesitant to place a side BET. Moreover, since a simple but a new game property of determining arrangement of symbols within the symbol display region is added, it is possible to further increase a fascinating factor of the game itself.

Also, in the side game, since the player only has to compare the dealt cards and the arrangement of symbols within the symbol display region, he or she can quickly see the result of the side game.

Since the special payout is made up by cumulatively accumulating part of the side-BET game media, the player has a possibility of gaining a large value of payout in a side game.

It is therefore possible to make the player have a strong desire of placing a side BET.

It is desirable that the gaming machine further has the following configuration.

Namely, the gaming machine further comprises a memory that stores a plurality of types of arrangement pattern data each showing an arrangement pattern of symbols in the symbol display region, wherein the processing (g) is the processing of displaying to the display the symbol display region in which the plurality of symbols are arranged in a matrix, based on an arrangement pattern data selected from the plurality of types of arrangement pattern data stored in the memory, when the side BET has been placed.

According to the above gaming machine, an arrangement pattern of symbols within the symbol display region displayed in a side game is selected from a plurality of types of arrangement patterns.

Accordingly, since a symbol display region with a different arrangement pattern is displayed every time a side BET is placed, it is possible to add variations to results of side games and further increase the game property.

It is desirable that the gaming machine further has the following configuration.

Namely, the processing (g) is the processing of displaying to the display the symbol display region in which the same number of symbols are arranged in rows and columns, when the side BET has been placed, and the processing (h) is the processing of offering a special payout from the game media cumulatively accumulated in the processing (c), when all symbols, which have been arranged in a single row, column and/or diagonal of the symbol display region, are symbols corresponding to the player's card and/or the dealer's card.

According to the above gaming machine, a special award is offered when symbols corresponding to the player's card and the dealer's card are arranged in an arrangement forming a bingo combination within the symbol display region in a side game.

It is possible to attract the attention of the players in a wide range of age groups by bringing a widely popular element of Bingo Game into the side game.

A third aspect of the present invention provides a playing method of a card game having the following configuration.

Namely, the playing method of a card game comprises: (a) accepting a normal BET, (b) accepting a side BET different from the normal BET, (c) dealing a player's card and a dealer's card, (d) executing a normal game in which winning or losing is determined based on the player's card and the dealer's card, (e) offering a normal payout based on the normal BET, when it has been determined that a player has won in the normal game, (f) arranging a plurality of symbols in a matrix, when the side BET has been placed, and (g) offering a special payout, when symbols corresponding to the player's card and the dealer's card are arranged in a specific arrangement, among the symbols arranged in the step (f).

According to the above-mentioned playing method of a card game, a normal game is executed by using a player's card and a dealer's card, and a plurality of symbols are arranged in a matrix as a side game, when a side BET has been placed. A special award is provided when symbols corresponding to the player's card and the dealer's card are displayed in a specific arrangement (e.g. an arrangement forming a bingo combination)

Since a side game (a game in which it is determined whether or not symbols corresponding to the player's card and the dealer's card are arranged in a specific arrangement) is conducted using the player's card and the dealer's card which have been dealt in the normal game, the side game is less apt to affect the game property of the normal game, and a player interested in the normal game is less apt to be hesitant to place a side BET. Moreover, since a simple but a new game property of determining arrangement of symbols is added, it is possible to further increase a fascinating factor of the game itself.

Also, in the side game, since the player only has to compare the dealt cards and the arrangement of symbols, he or she can quickly see the result of the side game.

When symbols corresponding to the player's card and the dealer's card are arranged in a specific arrangement in the side game, the player has a possibility of gaining a large value of payout by a special payout.

It is therefore possible to make the player have a strong desire of placing a side BET.

It is desirable that the playing method of a card game further has the following configuration.

Namely, the step (f) is the step of arranging the plurality of symbols in a matrix based on an arrangement pattern selected from a plurality of types of arrangement patterns, when the side BET has been placed.

According to the above playing method of a card game, an arrangement pattern of symbols arranged in a side game is selected from a plurality of types of arrangement patterns.

Accordingly, since symbols are displayed in a different arrangement pattern every time a side BET is placed, it is possible to add variations to results of side games and further increase the game property.

It is desirable that the playing method of a card game further has the following configuration.

Namely, the step (f) is the step of arranging the same number of symbols in rows and columns, and the step (g) is the step of offering a special payout, when all symbols arranged in a row, column and/or diagonal, out of the symbols arranged in the step (f), are symbols corresponding to the player's card and/or the dealer's card.

According to the above playing method of a card game, a special award is offered when symbols corresponding to the player's card and the dealer's card are arranged in an arrangement forming a bingo combination in a side game.

It is possible to attract the attention of the players in a wide range of age groups by bringing a widely popular element of Bingo Game into the side game.

### BRIEF DESCRIPTIONS OF THE DRAWINGS

FIG. 1A is a view illustrating an example of images displayed to a liquid crystal display provided in a station included in a gaming machine according to one embodiment of the present invention.

FIG. 1B is another view illustrating an example of images displayed to the liquid crystal display provided in the station included in the gaming machine according to one embodiment of the present invention.

FIG. 2 is a view illustrating corresponding relations between types of bingo card images and arrangement patterns of symbols.

FIG. 3 is a view illustrating corresponding relations among types of bingo card images, the number of established lines, and payout scale factors.

FIG. 4 is a perspective view schematically illustrating an external configuration of the gaming machine according to the present embodiment.

FIG. 5 is a perspective view schematically illustrating an external configuration of the station included in the gaming machine.

FIG. 6 is a view illustrating an example of images displayed to a front display included in the gaming machine.

FIG. 7 is a view illustrating an example of images displayed to the liquid crystal display included in the station.

FIG. 8 is a block diagram illustrating an internal configuration of the gaming machine.

FIG. 9 is a block diagram illustrating an internal configuration of a station included in the gaming machine.

FIG. 10 is a flowchart illustrating main processing conducted in a main control portion and the station.

FIG. 11 is a flowchart illustrating a procedure of activation processing.

FIG. 12A is a flowchart illustrating card game processing executed in the main control portion included in the gaming machine.

FIG. 12B is a flowchart illustrating card game processing executed in the main control portion included in the gaming machine.

FIG. 13A is a flowchart illustrating card game processing executed in the station.

FIG. 13B is another flowchart illustrating card game processing executed in the station.

### DESCRIPTION OF THE EMBODIMENTS

An embodiment of the present invention will be described based on drawings.

In the following embodiment, there will be described a case of conducting Blackjack. First, the rules of Blackjack will be described.

In Blackjack, a single or a plurality of players play a game against a dealer, using a deck of playing cards (52 cards). Winning or losing of a game is determined based on which score is the higher of the two between the total scores of cards dealt to the dealer and the player. However, when the total score of cards exceeds 21, he or she is bust. In the game, the player therefore aims to gain the highest possible score, insofar as the total score of cards is not exceeding 21. In Blackjack, concerning the method for counting a score of a card, there is provided a rule as follows. Namely, an ace is counted as 1 or 11. Face cards are all counted as 10. The other cards with numbers depicted thereon are counted at their own face values.

More specifically, a game progresses as follows. First, a BET is accepted. Then, two cards are dealt to each player who has placed a BET and the dealer. Each player looks at the cards dealt to him or her, and selects an action to take from “hit”, “stand”, “split” and “double”. Selecting “hit” indicates that the player asks for another card. Selecting “stand” indicates that the player does not ask for a card any more. Selecting “split” indicates that the player splits the two cards which have been dealt first and supplies a new card to each of those cards in order to play games separately, when those two cards have the same rank. Selecting “double” indicates that the player doubles the value of BET and asks for another card. Hereinafter, selection of one kind of action to take from four kinds of actions by the player will be referred to as a “BET selection”. When the BET selections by all the players in the game finish, the dealer hits a card until the total score of cards reaches 17 or more. When the total score of dealer's cards reaches 17 or more, winning or losing of the game is determined by comparing the total score of dealer's cards with the total score of player's cards. When the player wins, the player may newly acquire the value corresponding to the value of the BET. When the player loses, the player loses the value corresponding to the value of the BET. Further, when the first dealt cards are an ace and a card with the score of 10 (when the hand is Blackjack), the score of 21 formed by these two cards is stronger, as a hand, than the score of 21 formed by three cards or more. When the player holds a hand of Blackjack, the player may newly acquire the value corresponding to the value which is 1.5 times as large as the normal BET.

In the following embodiment, Blackjack will be executed in which a normal BET and an additional BET are accepted. Here, the normal BET is a BET to be placed on winning or losing of Blackjack, and an additional BET is a BET to be placed to execute a side game.

Part of the side-BET game media is cumulatively accumulated as a jackpot (hereinafter, also referred to as “JP”), and a payout in a side game is offered from the JP.

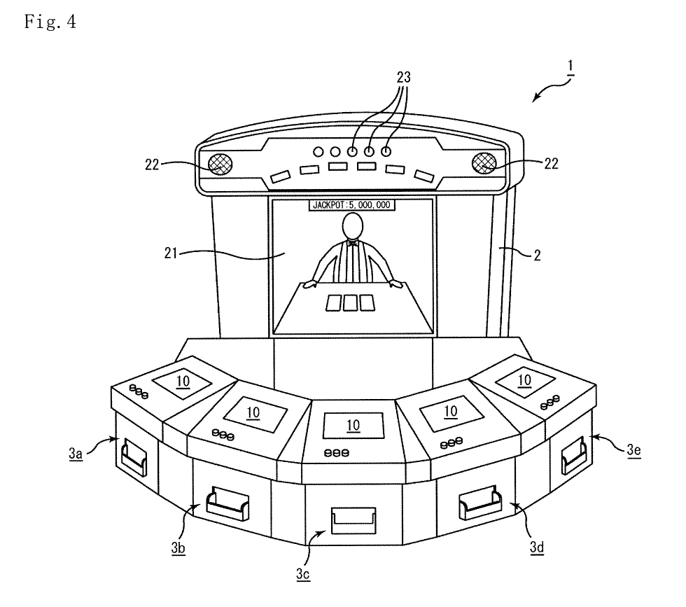

First, images will be described which are to be displayed to a liquid crystal display 10 of a station 3 included in a gaming machine 1 (see FIG. 4) according to the present embodiment when a side BET has been placed.

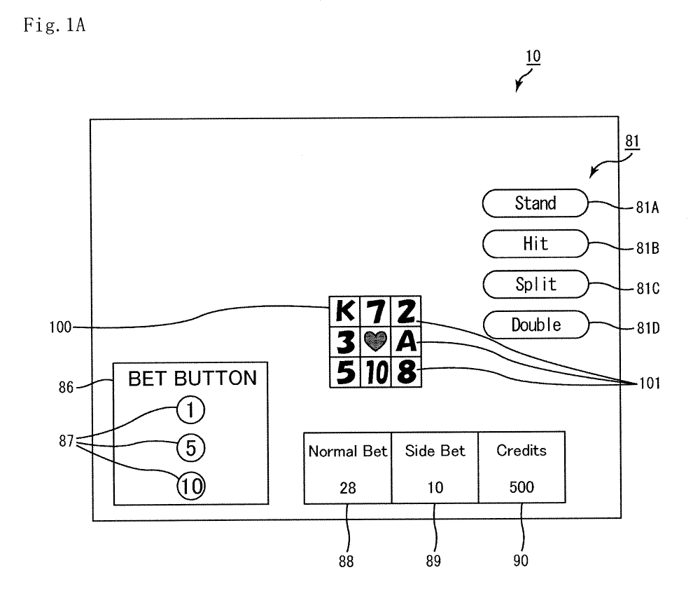

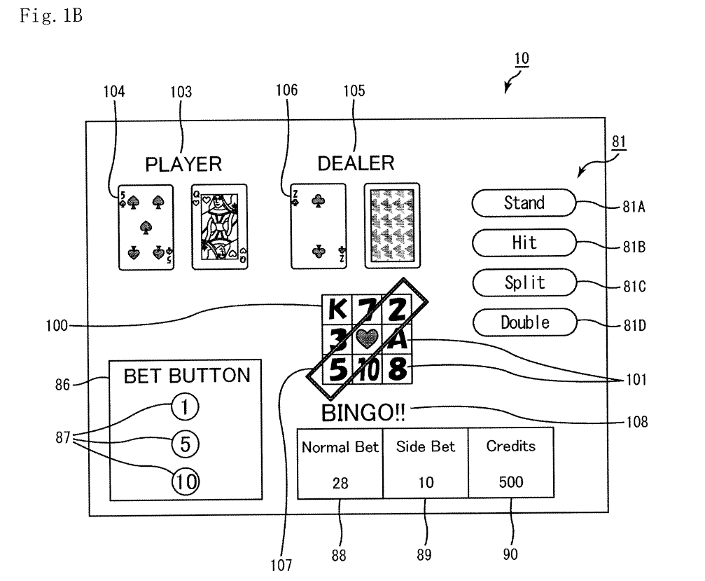

FIG. 1A and FIG. 1B are views illustrating examples of images displayed to a liquid crystal display provided in a station included in a gaming machine according to one embodiment of the present invention.

FIG. 1A illustrates an example of images displayed to the liquid crystal display 10 when a side BET has been placed.

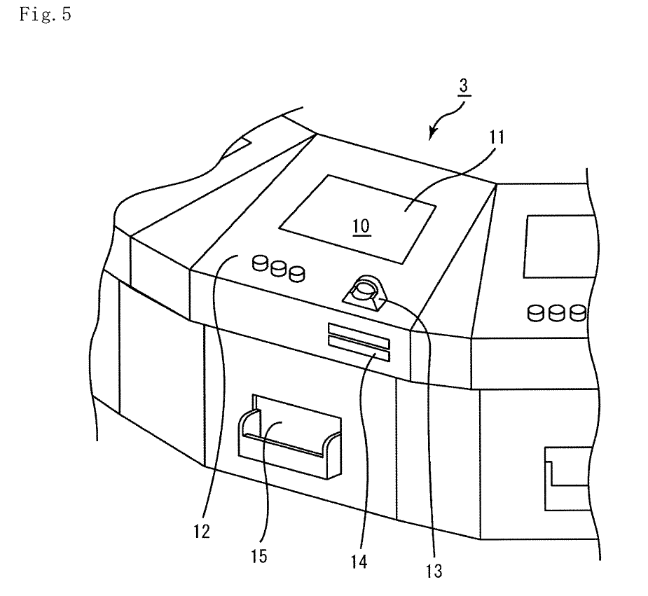

As shown in FIG. 1A, BET selection buttons 81 are provided on the upper right side of the liquid crystal display 10. The BET selection buttons 81 are comprised of four types of buttons: a stand button 81A; a hit button 81B; a split button 81C; and a double button 81D. The stand button 81A is a button for inputting a command of selecting “stand”, as a BET selection. The hit button 81B is a button for inputting a command to select “hit”, as a BET selection. The split button 81C is a button for inputting a command to select “split”, as a BET selection. The double button 81D is a button for inputting a command to select “double”, as a BET selection. The player can operate the respective buttons via a touch panel 11 (see FIG. 5), to make a BET selection.

A BET button display portion 86 is provided on the lower left side of the liquid crystal display 10. To the BET button display portion 86, BET buttons 87 for inputting the number of BETs are displayed. The player can operate the BET buttons 87 via the touch panel 11, to input the number of normal BETs and the number of side BETs.

To the right of the BET button display portion 86, there is provided a number-of-normal-BETs display portion 88 that displays the number of normal-BET coins. FIG. 1A shows that 28 coins have been betted. It should be noted that the player may operate a “10” BET button 87 twice, a “5” BET button 87 once, and a “1” BET button 87 three times.

To the right of the number-of-normal-BETs display portion 88, there is provided a number-of-side-BETs display portion 89 that shows the number of side-BET coins. FIG. 1A shows that 10 coins have been betted.

A number-of-credits display portion 90 is provided to the right of the number-of-side-BETs display portion 89. FIG. 1A shows that 500 coins have been credited.

On the upper side of the number-of-normal-BETs display portion 88 and the number-of-side-BETs display portion 89, a bingo card image 100 is displayed in which 9 symbols 101 are arranged in a matrix.

Each of the symbols 101 shows a number, letter of alphabet, or suit (heart, diamond, spade, club) of a playing card, and the types and the arrangement order of the symbols 101 to be displayed to the bingo card image 100 are determined based on a single arrangement pattern data selected from a plurality of kinds of arrangement pattern data stored in a ROM 43.

The bingo card image 100 corresponds to the symbol display region in the present invention.

When an input of BET has been finished, cards to be used in the normal game (Blackjack) are dealt as illustrated in FIG. 1B. Two cards each are dealt to the player and the dealer. The two player's cards are both displayed face up. One of the dealer's cards is displayed face up, and the other of the dealer's cards is displayed face down.

In FIG. 1B, a letter image 103 indicating a position for displaying player's cards is displayed on the left side of the liquid crystal display 10. Below the letter image 103, two player's cards 104 are displayed face up.

To the right of the letter image 103, a letter image 105 indicating a position for displaying dealer's cards is displayed. Below the letter image 105, two dealer's cards 106 are displayed such that one of these cards is displayed face up and the other card is displayed face down.

In the side game, the two player's cards and the one dealer's card displayed face up are used; and it is determined whether or not the symbols 101, which correspond to the numbers, letters of alphabet or suits of the respective three cards, are arranged in an arrangement that forms a bingo combination on the bingo card image 100.

In the example shown in FIG. 1B, the dealer's card 106 of “2 of Clubs” corresponds to the symbol 101 of “2”, the player's card 104 of “Queen of Hearts” corresponds to the symbol 101 of “Heart”, and the player's card 104 of “5 of Spades” corresponds to the symbol 101 of “5”; these 3 symbols 101 are forming a bingo combination on the bingo card image 100.

A line image 107, which indicates establishment of a bingo combination, is displayed so as to surround the symbols 101 of “2”, “Heart” and “5” on the bingo card image 100. Below the bingo card image 100, an image 108 is displayed which notifies establishment of a bingo combination.

As just described, when a bingo combination is established with the symbols 101 corresponding to the player's cards 104 and the dealer's card 106, a payout of JP is conducted based on the type of the bingo card image 100 (arrangement pattern of the symbols 101) and on the number of established bingo combination (the number of lines).

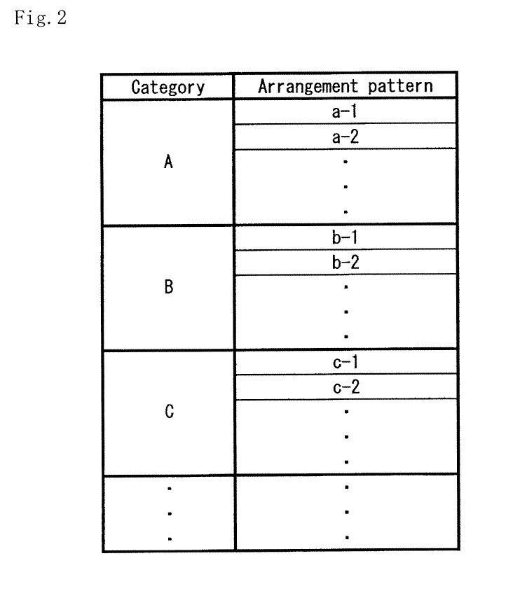

FIG. 2 is a view illustrating corresponding relations between the types of bingo card images and arrangement patterns of symbols.

As described above, in the present embodiment, the plurality of types of bingo card images 100 are prepared according to arrangement patterns of the symbols 101.

For example, a category A of the bingo card images 100, shown in FIG. 2, is a category in which all the 9 symbols 101 correspond to numbers or letters of alphabet of playing cards. Under this condition, a plurality of arrangement patterns (a-1, a-2, and so forth) having varied types (numbers or letters of alphabet) and arrangement orders of the symbols 101 to be displayed to the bingo card image 100 are set.

Examples of other categories of the bingo card images 100 may include: a category (including the arrangement pattern illustrated in FIG. 1A) in which the symbols 101 correspond to numbers, letters of alphabet or suits; and a category in which all the 9 symbols 101 correspond to suits of playing cards.

The arrangement patterns are stored in the ROM 43 as arrangement pattern data.

It is to be noted that an arrangement pattern of symbols within the symbol display region in the present invention is not limited to the above-mentioned example.

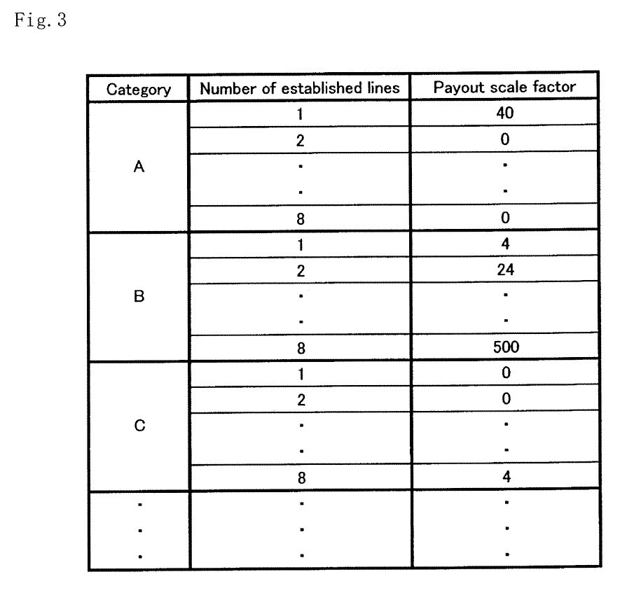

FIG. 3 is a view illustrating corresponding relations among types of bingo card images, the number of established lines and payout scale factors.

As shown in FIG. 3, payout scale factors are set for the types of bingo card images 100, in association with the numbers of established lines of bingo combinations with the symbols 101. For the types of bingo card images 100 having the possibility of establishment of bingo combinations along a plurality of lines, the payout scale factor is set so as to increase as the number of establishment lines increases.

Next, there will be described the gaming machine 1 according to the present embodiment.

FIG. 4 is a perspective view schematically illustrating an external configuration of the gaming machine according to the present embodiment.

As illustrated in FIG. 4, the gaming machine 1 is basically comprised of a main monitor 2 and five stations 3 (stations 3a to 3e ). Further, while, in the present embodiment, there will be described a case where the gaming machine 1 comprises a plurality of (five) stations 3, the number of stations included in a gaming machine may be one, in the present invention.

At the center portion of the main monitor 2, there is provided a front display 21 for displaying images indicating a dealer and cards. The front display 21 corresponds to the display in the present invention. Further, on the upper side of the main monitor 2, there are provided speakers 22 for outputting music and an effect sound along with the progression of a game executed in the gaming machine 1 and a plurality of LEDs 23 which are lighted during various types of effects.

FIG. 5 is a perspective view schematically illustrating an external configuration of a station included in the gaming machine illustrated in FIG. 4.

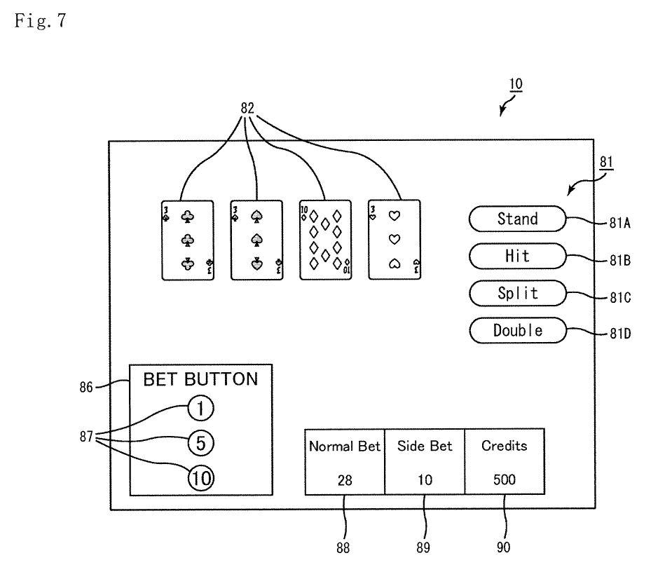

As illustrated in FIG. 5, at the center of the upper surface of the station 3, there is provided the liquid crystal display 10 for displaying a later-described image relating to an operation (see FIG. 7) and the like. The liquid crystal display 10 corresponds to the display in the present invention. Further, on the upper surface of the liquid crystal display 10, there is provided the touch panel 11 for inputting an operation for a BET and the like. The touch panel 11 corresponds to the input device in the present invention.

In front of the liquid crystal display 10, there are provided a plurality of operation buttons 12 used for performing a payout operation, and a coin insertion slot 13 into which a coin or a medal is inserted.

At the right end of the upper portion of the front surface of the station 3, there is provided a bill insertion slot 14 into which a bill is inserted. Below the bill insertion slot 14, there is provided a coin payout exit 15 that pays out coins or medals in number corresponding to the accumulated credits, to the player, when a payout operation is performed.

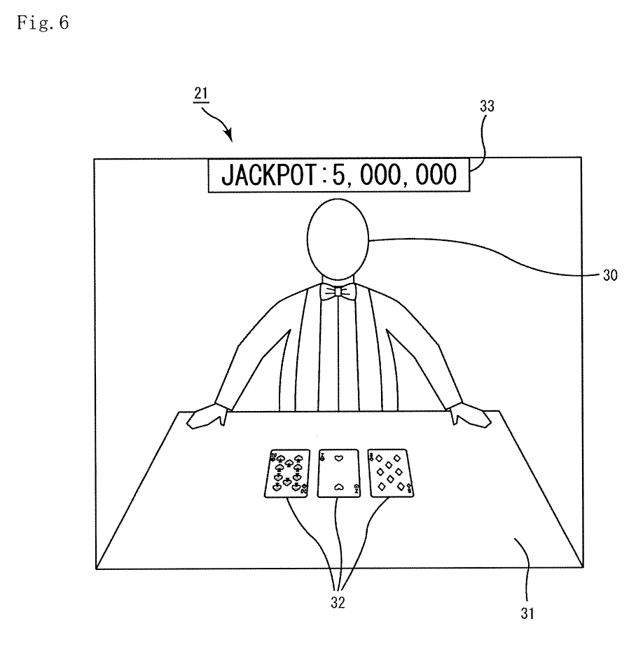

FIG. 6 is a view illustrating an example of images displayed to the front display included in the gaming machine.

As illustrated in FIG. 6, a JP display portion 33 for displaying the value of JP is provided on the upper side of the front display 21. Further, the front display 21 displays a dealer image 30 indicating a dealer, a table image 31 indicating a table, and card images 32 indicating dealer's cards. When cards are dealt to the dealer, one card out of the two card images 32 is displayed face up, and the other card is displayed face down. When BET selections by all players in the game finish, the card images 32 are displayed all face up, as shown in FIG. 6.

FIG. 7 is a view illustrating an example of images displayed to the liquid crystal display included in the station, in a normal game.

As illustrated in FIG. 7, as in FIG. 1A and FIG. 1B, the BET selection buttons 81, the BET button display portion 86, the number-of-normal-BETs display portion 88, the number-of-side-BETs display portion 89, and the number-of-credits display portion 90. Also, to the left of the BET selection buttons 81, card images 82 showing the player's cards are displayed face up.

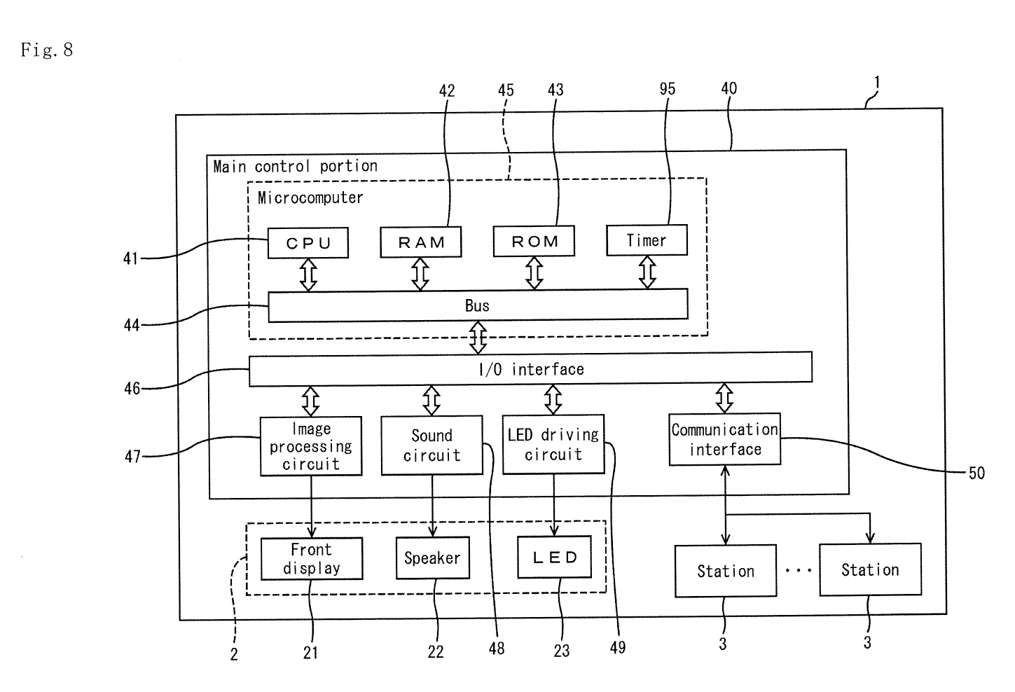

FIG. 8 is a block diagram illustrating an internal configuration of the gaming machine illustrated in FIG. 4.

As illustrated in FIG. 8, a main control portion 40 included in the gaming machine 1 comprises a microcomputer 45, as the core, which basically includes a CPU 41, a RAM 42, a ROM 43, a timer 95 and a bus 44 for transferring data mutually among these devices. The main control portion 40 corresponds to the controller in the present invention.

The ROM 43 stores various types of programs for conducting processing necessary for controlling the gaming machine 1, a data table and the like. The ROM 43 further stores the plurality of types of arrangement pattern data showing arrangement patterns of the symbols 101 on the bingo card image 100. The ROM 43 corresponds to the memory in the present invention. The RAM 42 is a memory for temporarily storing various types of data calculated in the CPU 41. The RAM 42 also stores a cumulatively added value of the JP, and the like.

Further, the timer 95 conducts time measurement.

Further, the CPU 41 is connected to an image processing circuit 47, a sound circuit 48, an LED drive circuit 49 and a communication interface 50, through an I/O interface 46.

The front display 21 included in the main monitor 2 is connected to the image processing circuit 47. The speakers 22 included in the main monitor 2 are connected to the sound circuit 48. The LEDs 23 included in the main monitor 2 are connected to the LED drive circuit 49. The five stations 3 are connected to the communication interface 50.

The CPU 41 proceeds with games (Blackjack and a side game) which are executed in the gaming machine 1, based on game programs (including a game program for Blackjack and a program for the side game) stored in the ROM 43 and on various types of signals received from the stations 3. Further, the CPU 41 displays an image to the front display 21, outputs sound from the speakers 22 and lights the LEDs 23, based on the above-mentioned game programs. Further, the CPU 41 transmits various types of signals to the respective stations 3, based on the above-mentioned game programs.

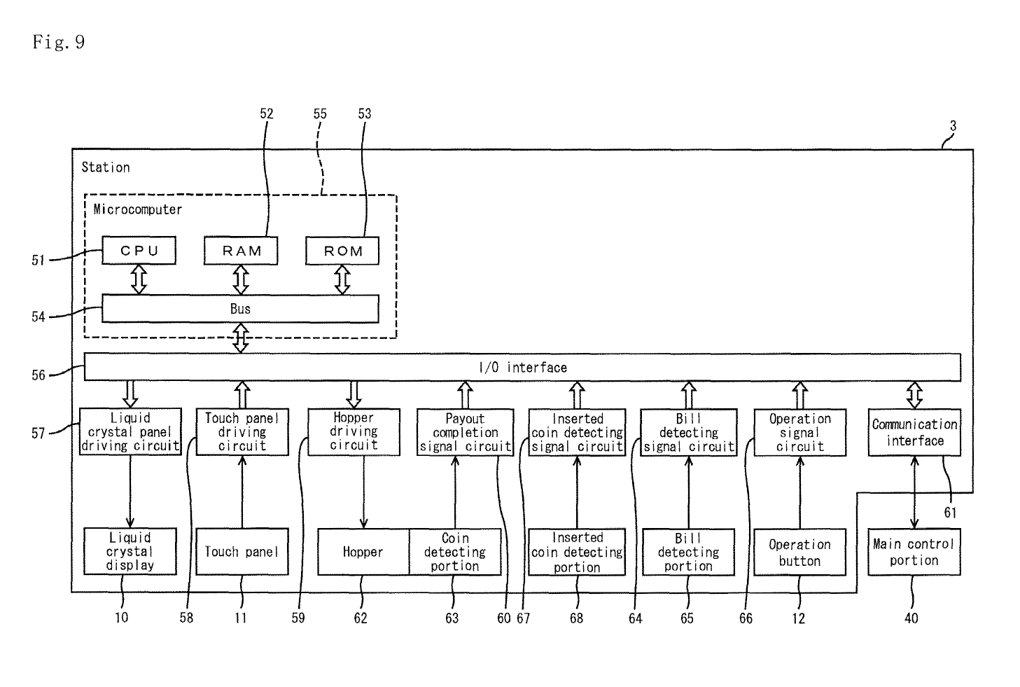

FIG. 9 is a block diagram illustrating the internal configuration of a station included in the gaming machine illustrated in FIG. 4.

As illustrated in FIG. 9, the station 3 comprises, as the core, a microcomputer 55 which is basically comprised of a CPU 51, a RAM 52, a ROM 53 and a bus 54 for transferring data mutually among these devices.

The ROM 53 stores various types of programs for conducting processing necessary for controlling the station 3, data tables and the like. Further, the RAM 52 temporarily stores the number of credits currently accumulated in the station 3 and various types of data calculated in the CPU 51.

Further, the CPU 51 is connected to a liquid crystal panel driving circuit 57, a touch panel driving circuit 58, a hopper driving circuit 59, a payout completion signal circuit 60, an inserted-coin detecting signal circuit 67, a bill detecting signal circuit 64, an operation signal circuit 66 and a communication interface 61, through an I/O interface 56.

The liquid crystal display 10 is connected to the liquid crystal panel driving circuit 57. The touch panel 11 is connected to the touch panel driving circuit 58. A hopper 62 is connected to the hopper driving circuit 59. A coin detecting portion 63 is connected to the payout completion signal circuit 60. An inserted-coin detecting portion 68 is connected to the inserted-coin detecting signal circuit 67. A bill detecting portion 65 is connected to the bill detecting signal circuit 64. The operation buttons 12 are connected to the operation signal circuit 66.

The hopper 62 is provided inside the station 3 and pays out a coin through the coin payout exit 15 based on a control signal outputted from the CPU 51.

The coin detecting portion 63 is provided inside the coin payout exit 15, and transmits a signal to the CPU 51, upon detection of payout of a predetermined number of coins through the coin payout exit 15.

The inserted-coin detecting portion 68, on detecting a coin being inserted from the coin insertion slot 13, detects the value of the coin and transmits to the CPU 51 a detecting signal indicative of the detected value. The detected value of the coin is counted regarding a predetermined value as 1 credit, and is stored in the RAM 52.

The bill detecting portion 65, on accepting a bill, detects the value of the bill and transmits to the CPU 51 a detecting signal indicative of the detected value. The detected value of the bill is counted regarding a predetermined value as 1 credit and is stored in the RAM 52.

The operation buttons 12 are buttons used for performing payout operations, when payout of the coin is determined.

Next, there will be described processing conducted in the main control portion 40 and the station 3.

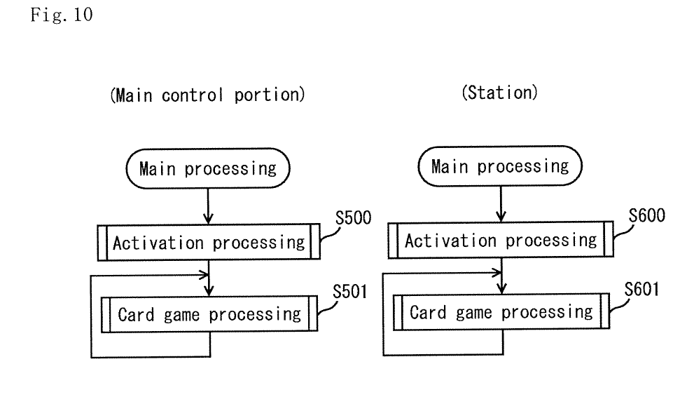

FIG. 10 is a flowchart showing main processing conducted in a main control portion and a station.

In the main control portion 40, the following main processing is conducted.

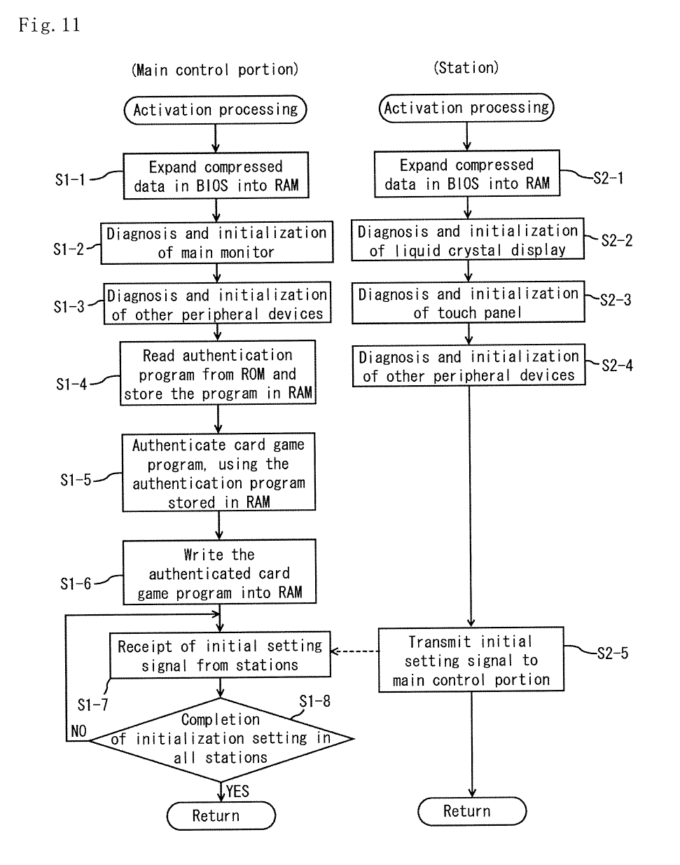

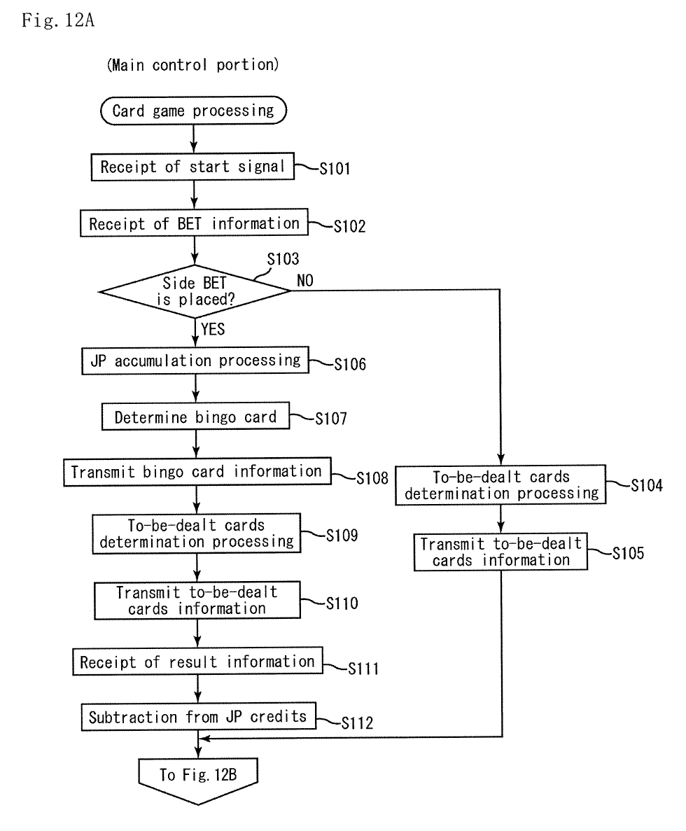

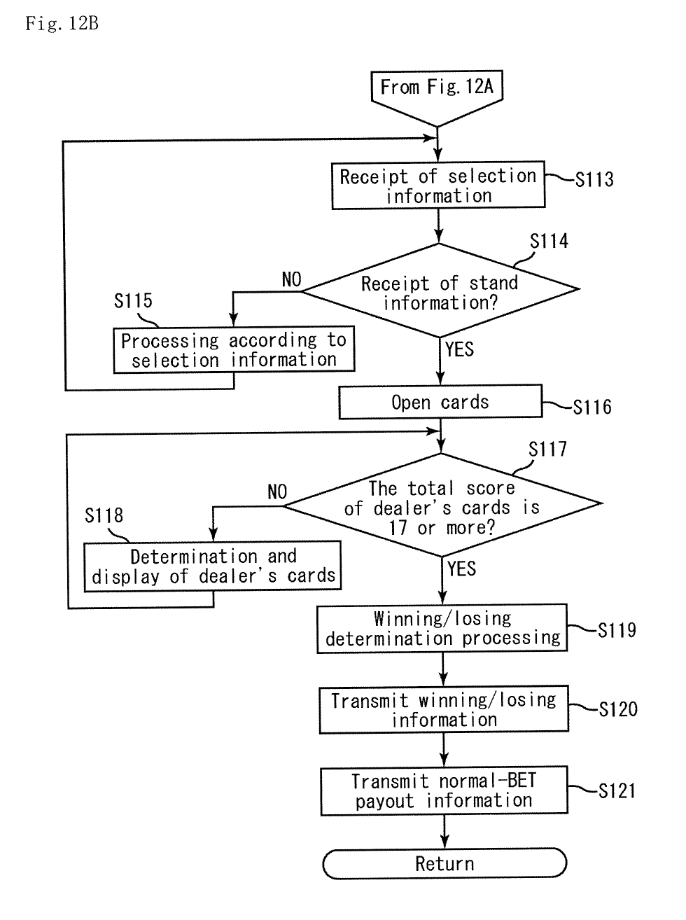

The CPU 41 in the main control portion 40 executes activation processing (step S500). The activation processing conducted in step S500 will be described later using FIG. 11. After executing the activation processing, the CPU 41 executes card game processing (step S501). The card game processing conducted in step S501 will be described later using FIG. 12A and FIG. 12B.

Meanwhile, in the station 3, the following main processing is conducted.

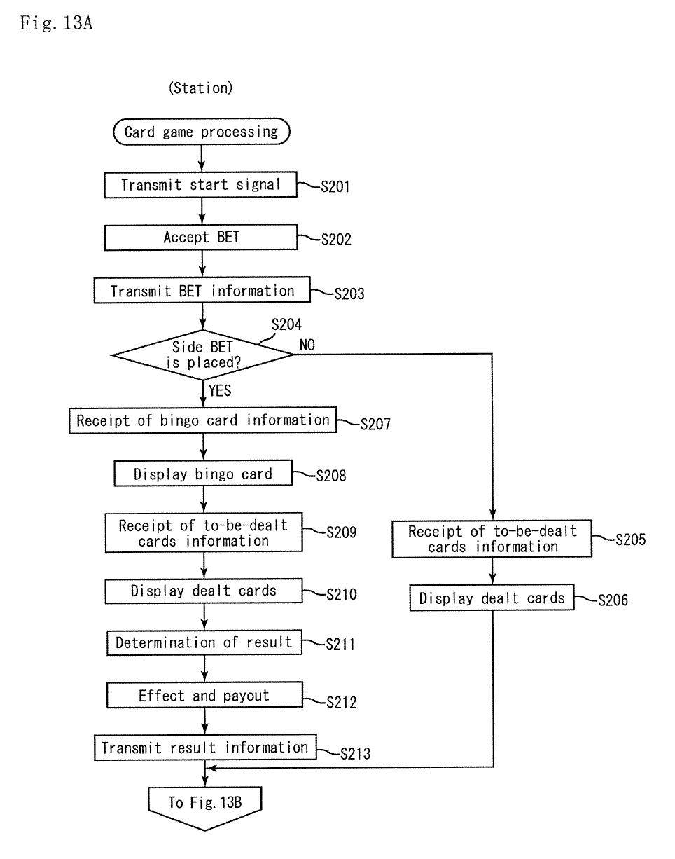

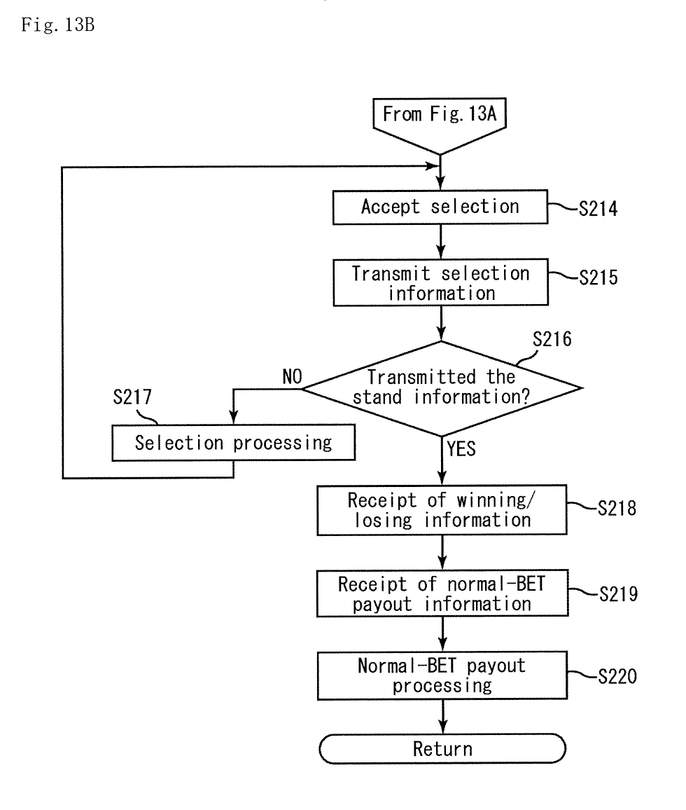

The CPU 51 in the station 3 executes activation processing (step S600). The activation processing conducted in step S600 will be described later using FIG. 11. After executing the activation processing, the CPU 51 executes card game processing (step S601). The card game processing conducted in step S601 will be described later using FIG. 13A and FIG. 13B.

FIG. 11 is a flowchart illustrating a procedure of the activation processing.

The activation processing is processing performed in the main control portion 40 and the station 3, as triggered by power-on (see step S500 and step S600 in FIG. 10).

At power-on, first, the CPU 41 of the main control portion 40 executes a BIOS stored in the ROM 43, and expands compressed data incorporated in the BIOS into the RAM 42 (step S1-11. The CPU 41 then executes the BIOS expanded into the RAM 42, and diagnoses and initializes a variety of peripheral devices.

Specifically, the CPU 41 diagnoses and initializes the main monitor 2 (step S1-2). In this processing, the CPU 41 transmits a request signal to the main monitor 2 and determines whether or not it has received a predetermined response signal, and conducts clearance of a predetermined storage region, and the like.

Next, the CPU 41 diagnoses and initializes the other peripheral devices connected to the CPU 41 (step S1-3).

Next, the CPU 41 reads an authentication program stored in the ROM 43, and also performs processing of storing the read authentication program into the RAM 42 (step S1-4). At this time, the CPU 41 obtains a checksum by ADDSUM system (standard checking function) in accordance with the standard BIOS function of the BIOS, and stores the authentication program into the RAM 42 while performing processing of checking whether or not the storage is performed without an error.

Next, the CPU 41 reads the card game program from the ROM 43. In this case, the CPU 41 reads data constituting the card game program by four bytes at a time. Subsequently, the CPU 41 performs authentication for checking and verifying that the read authentication program is authentic (not broken) in accordance with the authentication program stored in the RAM 42 (step S1-5). When properly completing this authentication processing, the CPU 41 writes and stores the card game program having been the object to be authenticated (having been authenticated), into the RAM 42 (step S1-6).

Meanwhile, the CPU 51 of the station 3 first executes a BIOS stored in the ROM 53, and expands compressed data incorporated in the BIOS into the RAM 52 (step S2-1). The CPU 51 then executes the BIOS expanded into the RAM 52 and diagnoses and initializes a variety of peripheral devices.

Specifically, the CPU 51 diagnoses and initializes the liquid crystal display 10 (step S2-2). In this processing, the CPU 51 transmits a request signal to the liquid crystal panel driving circuit 57, and determines whether or not it has received a predetermined response signal.

Next, the CPU 51 diagnoses and initializes the touch panel 11 (step S2-3). In this processing, the CPU 51 transmits a request signal to the touch panel 11, and determines whether or not it has received a predetermined response signal.

Next, the CPU 51 diagnoses and initializes the other peripheral devices connected to the CPU 51 (step S2-4).

Next, the CPU 51 transmits an initial setting signal to the main control portion 40 (step S2-5). The initial setting signal is a signal showing completion of diagnosis and initialization of the variety of peripheral devices provided in the station 3.

After executing the processing of step S2-5, the CPU 51 completes the present subroutine.

The CPU 41 of the main control portion 40 receives the initial setting signal transmitted by the station 3 in step S2-5 (step S1-7). Subsequently, the CPU 41 determines whether or not it has received the initial setting signals from all the stations 3 (step S1-8).

When determining that the initial setting signal has not been received from some of the stations 3, the CPU 41 returns the processing to step S1-7. On the other hand, when determining that the initial setting signals have been received from all the stations 3, the CPU 41 completes the present subroutine.

Subsequently, the card game processing conducted in the gaming machine 1 is described.

First, processing executed in the main control portion 40 is described.

FIG. 12A and FIG. 12B are flowcharts illustrating the card game processing executed in the main control portion included in the gaming machine.

In step S101 in FIG. 12A, the CPU 41 included in the main control portion 40 receives a start signal from any of the stations 3. The start signal is a signal which makes a game of Blackjack progress in the gaming machine 1.

Next, in step S102, the CPU 41 receives BET information from the station 3. The BET information is information relating to BETs and including information about whether or not a normal BET and a side BET are placed and the values of the normal BET and the side BET.

Next, in step S103, based on the BET information received in step S102, the CPU 41 determines whether or not a side BET has been placed. Namely, based on the BET information, the CPU 41 determines whether or not there is a station 3 in which a side BET has been placed.

When determining that a side BET has not been placed, the CPU 41 determines, in step S104, two cards each to be dealt to the player and the dealer, out of a deck of playing cards, using random numbers. The two cards determined to be dealt to the player in step S104 are referred to as player's cards, while the two cards determined to be dealt to the dealer are referred to as dealer's cards. Further, as card images indicative of the two dealer's cards, one card is displayed face up and the other card is displayed face down, to the front display 21 included in the gaming machine 1 (see FIG. 6).

Next, in step S105, the CPU 41 transmits to-be-dealt cards information to the station 3. The to-be-dealt cards information includes information indicative of the types of the cards determined to be dealt to the player and the dealer (ranks and suits [heart, club, spade, diamond]). The station 3 displays card images indicative of the two player's cards to the liquid crystal display 10, based on the received to-be-dealt cards information.

After executing the processing of step S105, the CPU 41 shifts the processing to step S113.

When determining in step S103 that a side BET has been placed, the CPU 41 cumulatively stores, into the RAM 42, credits corresponding to 50% of the side-BET game media as a JP, in step S106.

Next, in step S107, the CPU 41 determines a bingo card to be used in a side game. More specifically, the CPU 41 selects a single category from the plurality of types of bingo cards illustrated in FIG. 2, and then selects a single arrangement pattern data from the plurality of types of arrangement pattern data belonging to this category, so as to determine a bingo card to be displayed to the liquid crystal display 10 of the station 3.

Subsequently, in step S108, the CPU 41 transmits bingo card information to a station 3 in which a side BET has been placed. The bingo card information is information showing arrangement pattern of the symbols on the bingo card that has been determined in step S107.

On a station 3 having received the bingo card information, the bingo card image 100 is displayed to the liquid crystal display 10, based on the bingo card information (see FIG. 1A).

Next, in step S109, the CPU 41 determines two cards each to be dealt to all the players and the dealer, out of a deck of playing cards, using random numbers. The two cards determined to be dealt to the player in step S109 are referred to as the player's cards, and the two cards determined to be dealt to the dealer are referred to as the dealer's cards. Further, as card images indicative of the two dealer's card, one card is displayed face up and the other card is displayed face down, to the front display 21 included in the gaming machine 1 (see FIG. 6).

In step S110, the CPU 41 transmits to-be-dealt cards information to all of the stations 3. To-be-dealt cards information includes information showing the types of cards (ranks and suits [heart, club, spade, diamond]) to be dealt to the player and the dealer.

Each station 3 display card images indicative of the two player's cards to the liquid crystal display 10, based on the received to-be-dealt cards information.

Moreover, a station 3 in which a side BET has been placed displays the player's cards and the dealer's cards to the liquid crystal display 10, so as to proceed with a side game (see FIG. 1B).

In step S111, the CPU 41 receives result information from the station 3 in which side BET has been placed. The result information is information showing the value of JP paid out in a side game.

In step S112, the CPU 41 makes a subtraction from the credits of JP stored in the RAM 42, based on the result information received in step S111.

After executing the processing of step S112, the CPU 41 advances the processing to step S113.

Next, in step S113 in FIG. 12B, the CPU 41 receives selection information from the respective stations 3. The selection information is information relating to the BET selection conducted by the player.

Next, in step S114, the CPU 41 determines whether or not it has received stand information as selection information in the step S113. Stand information is information indicative of the player's selection of “stand” as a BET selection.

When the CPU 41 determines that stand information has not been received (step S114: No), the CPU 41 conducts processing corresponding to the BET selection conducted by the player, based on the selection information received in step S113 (step S115). More specifically, when receiving information indicative of the player's selection of “hit”, the CPU 41 determines a single card to be dealt to the player using random numbers, and transmits information on this card, as to-be-dealt cards information, to the station 3 where this player is playing the game. When the CPU 41 receives information indicative of the player's selection of “split”, the CPU 41 splits the two cards into 2, the cards being displayed to the liquid crystal display 10 in the station 3 where the player is playing a game. Then, the CPU 41 determines a single card to be newly supplied to the each split card, using random numbers, and transmits information on the determined cards, as to-be-dealt cards information, to the station 3 where the player is playing the game. When receiving information indicative of the player's selection of “double”, the CPU 41 determines a single card to be dealt to the player using a random number and transmits information on this card, as to-be-dealt cards information, to the station 3 where the player is playing the game. On receiving the to-be-dealt cards information, the station 3 displays a card image corresponding to the to-be-dealt cards information, to the liquid crystal display 10.

After conducting the processing of step S115, the CPU 41 returns the processing to step S113.

When determining that stand information has been received in step S114 (step S114: Yes), the CPU 41 displays two card images indicative of the dealer's cards face up, to the front display 21 (step S116).

Next, in step S117, the CPU 41 determines whether or not the total score of the dealer's cards is equal to or more than 17.

When determining that the total score of the dealer's cards is less than 17 (step S117: No), the CPU 41 conducts hit processing (step S118). The hit processing is processing for adding a single card to the dealer's cards. More specifically, the CPU 41 determines a single card by using random numbers, adds this card to the dealer's cards and displays this card face up to the front display 21. After conducting the processing of step S118, the CPU 41 returns the processing to step S117.

When determining that the total score of the dealer's cards is equal to or more than 17 (step S117: Yes), the CPU 41 conducts winning or losing determination processing (step S119) More specifically, the CPU 41 determines winning or losing of the game by determining which score is the higher of the two by comparing the total score of the dealer s cards with the total score of the player's cards.

Next, in step S120, the CPU 41 transmits, to the station 3, information indicative of winning or losing of the game determined in step S119 (hereinafter, also referred to as “winning/losing information”). On receiving the winning/losing information, the station 3 displays a single image describing any one of “you win”, “you lose” and “tie” to the liquid crystal display 10, based on the winning/losing information.

Next, in step S121, the CPU 41 transmits normal-BET payout information to the station 3. The normal-BET payout information is information indicative of the value of credit (game media) to be paid out for a normal BET. More specifically, when the player wins, the CPU 41 transmits information indicative of a value of credit which is twice the value of the normal BET, and in the event of a tie, the CPU 41 transmits information indicative of the same value of credit as the value of the normal BET. Also, when the dealer wins, the CPU 41 transmits information indicating that the value of credit to be offered is 0.

After conducting the processing of step S121, the CPU 41 ends the present subroutine.

It is to be noted that the game, which is conducted during execution of the processing of step S101 to step S105 and step S113 to step S121, corresponds to the normal game in the present invention, and the game, which is conducted during execution of the processing of step S106 to step S112, corresponds to the side game in the present invention.

FIGS. 13A and 13B are flowcharts illustrating card game processing executed in the station.

First, in step S201 in FIG. 13A, the CPU 51 included in the station 3 transmits a start signal to the main control portion 40, when receiving from the touch panel 11 a signal indicating detection of a contact, or when receiving from the inserted-coin detecting portion 68 a signal indicating detection of coin insertion. Then, the processing illustrated in FIGS. 12A and 12B is proceeded in the main control portion 40.

Next, in step S202, the CPU 51 accepts inputs of a normal BET and a side BET. This enables the player to input a normal BET and a side BET through the touch panel 11 included in the station 3.

Next, in step S203, the CPU 51 transmits BET information on the inputted BET, to the main control portion 40.

Next, in step S204, the CPU 51 determines whether or not a side BET has been placed in step S202.

When determining that a side BET has not been placed, the CPU 51 receives to-be-dealt cards information indicating the cards to be dealt to the player from the main control portion 40, in step S205.

Next, in step S206, the CPU 51 displays card images indicative of the two player's cards to the liquid crystal display 10, based on the to-be-dealt cards information received in step S205.

After executing the processing of step S206, the CPU 51 shifts the processing to step S214.

When determining that a side BET has been placed in step S204, the CPU 51 receives bingo card information from the main control portion 40, in step S207. The bingo card information is information showing the arrangement pattern of symbols on the bingo card used in the side game.

In step S208, the CPU 51 displays to the liquid crystal display 10 the bingo card image 100 (see FIG. 1A), based on the bingo card information received in step S207.

Next, in step S209, the CPU 51 receives the to-be-dealt cards information showing the cards to be dealt to the player and the dealer, from the main control portion 40.

In step S210, the CPU 51 displays to the liquid crystal display 10 the card images showing the two player's cards and the two dealer's cards (see FIG. 1B), based on the to-be-dealt cards information received in step S209. At this time, one card out of the two dealer's cards is displayed face down.

Next, in step S211, the CPU 51 determines the result of the side game. More specifically, the CPU 51 determines whether or not the symbols corresponding to the three cards (two player's cards and one dealer's card) displayed face up in step S210, among the symbols on the bingo card which have been displayed in step S208, are arranged in an arrangement forming a bingo combination. When a bingo combination has been established, the CPU 51 determines the value of JP to offer, based on the bingo combination (see FIG. 3).

In step S212, the CPU 51 performs effects (see FIG. 1B) based on the result determined instep S211, and conducts payout of JP in the determined value.

Next, in step S213, the CPU 51 transmits result information to the main control portion 40. The result information is information showing the value of JP determined in step S211.

After executing the processing of step S213, the CPU 51 shifts the processing to step S214.

In step S214 in FIG. 13B, the CPU 51 accepts a BET selection. In response to this acceptance, the player makes a BET selection through the touch panel 11.

Next, in step S215, the CPU 51 transmits selection information to the main control portion 40. The selection information is information relating to the BET selection made by the player in step S214.

Next, in step S216, the CPU 51 determines whether or not it has transmitted stand information as selection information in step S215. The stand information is information indicative of the player's selection of “stand” as a BET selection.

When determining that the CPU 51 has not transmitted stand information (step S216: No), namely, when the player has made a selection other than “stand” as a BET selection, the CPU 51 conducts processing corresponding to the player's BET selection (selection processing) (step S217). More specifically, based on the to-be-dealt cards information transmitted from the main control portion 40 in step S105, the CPU 51 displays card images corresponding to the to-be-dealt cards information, to the liquid crystal display 10. Also, when the player selects “split” or “double” as a BET selection, the CPU 51 conducts processing for doubling the value of BET. Namely, the CPU 51 conducts processing for subtracting a value corresponding to the value of normal BET inputted in step S202 from the number of credits accumulated in the RAM 52, and conducts processing for adding this value to the value of normal BET.

After executing the processing of step S217, the CPU 51 returns the processing to step S214.

When determining that the CPU 51 has transmitted stand information in step S216 (step S216: Yes), the CPU 51 receives winning/losing information from the main control portion 40 (step S218). Subsequently, the CPU 51 displays an image indicating any one of “you win”, “you lose” and “tie” to the liquid crystal display 10 for a predetermined time period (10 seconds, in the present embodiment), based on the received winning/losing information.

Next, in step S219, the CPU 51 receives normal-BET payout information from the main control portion 40. On receiving the normal-BET payout information, the CPU 51 stores, in the RAM 52, credit data based on the normal-BET payout information.

Next, in step S220, the CPU 51 pays out credits, based on the normal-BET payout information received in step S213.

After executing the processing of step S220, the CPU 51 ends the present subroutine.

As described above, the gaming machine 1 according to the present embodiment comprises: the front display 21 and the liquid crystal display 10 (display) which are capable of displaying an image; the touch panel 11 (input device); and the main control portion 40 (controller). The main control portion 40 is programmed to conduct the processing of (a) accepting a normal BET from the touch panel 11, (b) accepting a side BET different from the normal BET, from the touch panel 11, (c) displaying player's cards and dealer's cards to the front display 21 and the liquid crystal display 10, (d) executing a normal game in which winning or losing is determined based on the player's cards and the dealer's cards, (e) offering a normal payout based on the normal BET, when it has been determined that a player has won in the normal game, (f) displaying to the liquid crystal display 10 the bingo card image 100 in which the plurality of symbols 101 are arranged in a matrix, when the side BET has been placed, and (g) offering a special payout, when symbols 101 corresponding to the player's cards and the dealer's card are arranged in an arrangement forming a bingo combination on the bingo card image 100.

According to the above gaming machine 1, since a side game (a game in which it is determined whether or not symbols corresponding to the player's cards and the dealer's card are arranged in a specific arrangement on the bingo card 100) is conducted using the player's cards and the dealer, s cards which have been dealt in the normal game, the side game is less apt to affect the game property of the normal game, and a player interested in the normal game is less apt to be hesitant to place a side BET. Moreover, since a simple but a new game property of determining arrangement of symbols on the bingo card 100 is added, it is possible to further increase a fascinating factor of the game itself.

Also, in the side game, since the player only has to compare the dealt cards and the arrangement of symbols on the bingo card 100, he or she can quickly see the result of the side game.

When symbols corresponding to the player's cards and the dealer's card are arranged in an arrangement forming a bingo combination on the bingo card image 100 in the side game, the player has a possibility of gaining a larger value of payout by a special payout.

It is therefore possible to make the player have a strong desire of placing a side BET.

According to the above gaming machine 1, an arrangement pattern of symbols on the bingo card image 100 displayed in a side game is selected from a plurality of types of arrangement patterns.

Accordingly, since a bingo card image 100 with a different arrangement pattern is displayed every time a side BET is placed, it is possible to add variations to the result of side games and further increase the game property.

It is possible to attract the attention of the players in a wide range of age groups by bringing a widely popular element of Bingo Game into the side game.

In the present embodiment, a case has been described where a special payout is always offered from the JP when symbols corresponding to the player's cards and the dealer's card have been arranged in an arrangement forming a bingo combination on the bingo card image 100 (symbol display region). However, the special payout in the present invention may not always be offered from the JP.

For example, a supply source of the special payout may be changed according to the arrangement of symbols corresponding to the player's cards and the dealer's card in the symbol display region, e.g. the special payout may be offered from the JP only when the number of established lines on the bingo card has reached a specific number (e.g. 8 lines).

In the present embodiment, a case has been described where the special payout is offered when symbols corresponding to the player's cards and the dealer's card are arranged in an arrangement forming a bingo combination on the bingo card image 100 (symbol display region). However, the specific arrangement in the present invention is not limited to this example; it may be for example an arrangement in which two or more symbols corresponding to the player's card and the dealer's card are arranged next to each other.

Further, although a case has been described in the present embodiment where three cards are used in the side game, the number of cards to be used in the side game is not particularly limited in the present invention.

Also, although a case has been described in the present embodiment where Blackjack is played as the normal game, the normal game in the present invention is not particularly limited so long as it is a game in which a player plays against a dealer.

Furthermore, in the present invention, selection processing of the arrangement pattern of symbols and determination processing of the player's cards and the dealer's cards may be controlled such that symbols corresponding to the player's card and the dealer's card are surely arranged in the specific arrangement within the symbol display region at a predetermined frequency (e.g. once in several games).

Although the present invention has been described with reference to embodiments thereof, these embodiments merely illustrate specific examples, not restrict the present invention. The specific structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there has been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United Stated is:

1. A gaming machine comprising:
a display capable of displaying an image;
an input device; and
a controller,
said controller programmed to conduct the processing of
(a) accepting a normal BET from said input device,
(b) accepting a side BET different from said normal BET, from said input device,
(c) displaying to said display a player's card and a dealer's card,
(d) executing a normal game in which winning or losing is determined based on said player's card and said dealer's card,
(e) offering a normal payout based on said normal BET, when it has been determined that a player has won in said normal game,
(f) displaying to said display a symbol display region in which a plurality of symbols are arranged in a matrix, when said side BET has been placed, and
(g) offering a special payout, when symbols corresponding to said player's card and said dealer's card are arranged in a specific arrangement within said symbol display region.

2. The gaming machine according to claim 1, further comprising
a memory that stores a plurality of types of arrangement pattern data each showing an arrangement pattern of symbols in said symbol display region,
wherein
said processing (f) is the processing of
displaying to said display the symbol display region in which the plurality of symbols are arranged in a matrix, based on an arrangement pattern data selected from the plurality of types of arrangement pattern data stored in said memory, when said side BET has been placed.

3. The gaming machine according to claim 1,
wherein
said processing (f) is the processing of
displaying to said display the symbol display region in which the same number of symbols are arranged in rows and columns, when said side BET has been placed, and
said processing (g) is the processing of
offering a special payout, when all symbols, which have been arranged in a single row, column and/or diagonal of said symbol display region, are symbols corresponding to said player's card and/or said dealer's card.

4. A gaming machine comprising:
a display capable of displaying an image;
an input device; and
a controller,
said controller programmed to conduct the processing of
(a) accepting a normal BET from said input device,
(b) accepting a side BET different from said normal BET, from said input device,
(c) cumulatively accumulating a predetermined ratio of game media that have been placed as a side BET in said processing (b),
(d) displaying to said display a player's card and a dealer's card,
(e) executing a normal game in which winning or losing is determined based on said player's card and said dealer's card,
(f) offering a normal payout based on said normal BET, when it has been determined that a player has won in said normal game,
(g) displaying to said display a symbol display region in which a plurality of symbols are arranged in a matrix, when said side BET has been placed, and
(h) offering a special payout from the game media cumulatively accumulated in said processing (c), when symbols corresponding to said player is card and said dealer's card are arranged in a specific arrangement within said symbol display region.

5. The gaming machine according to claim 4, further comprising
a memory that stores a plurality of types of arrangement pattern data each showing an arrangement pattern of symbols in said symbol display region,
wherein
said processing (g) is the processing of
displaying to said display the symbol display region in which the plurality of symbols are arranged in a matrix, based on an arrangement pattern data selected from the plurality of types of arrangement pattern data stored in said memory, when said side BET has been placed.

6. The gaming machine according to claim 4,
wherein
said processing (g) is the processing of
displaying to said display the symbol display region in which the same number of symbols are arranged in rows and columns, when said side BET has been placed, and
said processing (h) is the processing of
offering a special payout from the game media cumulatively accumulated in said processing (c), when all symbols, which have been arranged in a single row, column and/or diagonal of said symbol display region, are symbols corresponding to said player's card and/or said dealer's card.

7. A playing method of a card game comprising the steps of:
(a) accepting a normal BET,
(b) accepting a side BET different from said normal BET,
(c) dealing a player's card and a dealer's card,
(d) executing a normal game in which winning or losing is determined based on said player's card and said dealer's card,
(e) offering a normal payout based on said normal BET, when it has been determined that a player has won in said normal game,
(f) arranging a plurality of symbols in a matrix, when said side BET has been placed, and
(g) offering a special payout, when symbols corresponding to said player's card and said dealer's card are arranged in a specific arrangement, among the symbols arranged in said step (f).

8. The playing method of a card game, according to claim 7,
wherein
said step (f) is the step of
arranging the plurality of symbols in a matrix based on an arrangement pattern selected from a plurality of types of arrangement patterns, when said side BET has been placed.

9. The playing method of a card game, according to claim 7,
wherein
said step (f) is the step of
arranging the same number of symbols in rows and columns, when said side BET has been placed, and
said step (g) is the step of
offering a special payout, when all symbols arranged in a row, column and/or diagonal, out of the symbols arranged in said step (f), are symbols corresponding to said player's card and/or said dealer's card.
